(19) United States
(12) Patent Application Publication
(10) Pub. No.: US 2013/0113793 A1
(43) Pub. Date: May 9, 2013

(54) IMAGE PROCESSING DEVICE, IMAGE PROCESSING METHOD, AND IMAGE PROCESSING PROGRAM

(71) Applicant: FUJIFILM CORPORATION, Tokyo (JP)

(72) Inventor: Akihiro UCHIDA, Saitama-shi (JP)

(73) Assignee: FUJIFILM CORPORATION, Tokyo (JP)

(21) Appl. No.: 13/729,228

(22) Filed: Dec. 28, 2012

Related U.S. Application Data
(63) Continuation of application No. PCT/JP2011/003722, filed on Jun. 29, 2011.

(30) Foreign Application Priority Data
Jun. 30, 2010 (JP) 2010-149387

(51) Int. Cl. G06T 15/00

(52) U.S. Cl. CPC G06T 15/00
USPC 345/419

(57) ABSTRACT

A parallax amount between the plurality of images for each subject on the images is calculated, a subject having an absolute parallax value which exceeds a first predetermined amount as a subject targeted for display position adjustment, using a cross point provisionally set for the plurality of images as a reference is identified, and parallax is gradually adjusted such that the absolute parallax value of the subject targeted for display position adjustment does not exceed a second predetermined amount after adjustment. In this case, a subject having an absolute parallax value which exceeds a third predetermined amount is identified as a subject to be blurred, in each of an image having the provisional cross-point position, an image undergoing parallax adjustment, and an image after the parallax adjustment, and a blur process is performed on the subject to be blurred within the images.

### TECHNICAL FIELD

The present invention relates to an image processing device and an image processing method for performing three-dimensional processing on a plurality of images with different viewpoints to enable stereoscopic viewing of the images, and for generating stereoscopic images which are stereoscopically displayed on a display means for stereoscopically display, as well as a program for causing a computer to carry out the three-dimensional processing method.

### BACKGROUND ART

Enabling stereoscopic viewing utilizing parallax by combining a plurality of images obtained by imaging the same subject from different positions such that stereoscopic images are generated, thereby stereoscopically displaying the generated stereoscopic image, is known. As a specific method for the stereoscopic display, a naked-eye parallel viewing method that stereoscopically displays images by arranging a plurality of images side by side is known. Further, the three-dimensional display may be achieved by combining images, for example, by overlapping the images while changing the colors of the images, such as into red and blue, or by overlapping the images while providing different polarization directions of the images. In these cases, the stereoscopic viewing can be achieved by using image separating glasses, such as red-and-blue glasses or polarization glasses, to provide a merged view of the images displayed for three-dimensional viewing (anaglyph system, polarization filter system).

Furthermore, stereoscopic viewing may be achieved by displaying images on a stereoscopic display monitor that enables stereoscopic viewing, such as that of a parallax barrier system or a lenticular system, without using polarization glasses, etc. In this case, stereoscopic viewing display is achieved by alternately arranging vertical strips of the images. Moreover, a method for providing a stereoscopic display using a residual image effect created by alternately and quickly displaying left and right images while changing directions of light beams from the left and right images by the use of image separation glasses or by attaching an optical element on a liquid crystal display has been proposed (scanning backlight system).

During stereoscopically display by the methods described above, it is necessary to appropriately adjust the stereoscopic effect of the stereoscopic images. This is because there has been a problem that a user will suffer from eye fatigue if some subjects are projected excessively forward. Hence, there has been proposed a method for generating a stereoscopic image based on an appropriate parallax amounts, which is judged for the stereoscopic image being stereoscopically displayed (see Japanese Unexamined Patent Publication No. 8(1996)-211332, hereinafter referred to as patent document 1). Further, there has been proposed a method for detecting a distance from a user's eyes to a fixation point, and focusing on a subject a user is looking at, while blurring a subject the user is not looking at so as to avoid directing a user's attention toward the subject which is projected excessively forward (see Japanese Unexamined Patent Publication No. 10(1998)-239634, hereinafter referred to as patent document 2).

### DISCLOSURE OF THE INVENTION

However, in patent document 1, when it is judged that the parallax amount of the currently displayed stereoscopic image is not appropriate, the parallax amount will be immediately adjusted so that the parallax amount is rapidly changed. Thus, there is a problem that this rapid change of the parallax amount causes a user to feel discomfort.

Further, the method of patent document 2 includes focusing on a subject a user is looking at. In the case that a user looks at a subject, which is projected excessively forward, this subject is caused to be focused on, and thereby the user fixes their eyes on the subject. As a result, there is a problem that this fails to suppress the user's eyes fatigue.

The present invention has been developed in view of the foregoing circumstances. It is an object of the present invention to appropriately adjust the stereoscopic effect of stereoscopic images and to prevent a user from feeling discomfort at the time of adjustment.

The image processing apparatus according to the present invention sets a predetermined point which corresponds to each other within a plurality of images with different viewpoints as a cross point and generates a stereoscopic image which is stereoscopically displayed on a display means for stereoscopically display by performing a parallax adjustment on the plurality of images such that parallax becomes 0 at a position of a cross point, is characterized by being equipped with: parallax amount calculation means for calculating a parallax amount among the plurality of images for each subject within the images; subject targeted for display position adjustment identification means for identifying a subject having an absolute parallax value which exceeds a first predetermined amount as a subject targeted for display position adjustment, using a cross point provisionally set for the plurality of images as a reference; parallax adjustment means for gradually adjusting parallax such that the absolute parallax value of the subject targeted for display position adjustment does not exceed a second predetermined amount after adjustment; subject to be blurred identification means for identifying a subject having an absolute parallax value which exceeds a third predetermined amount as a subject to be blurred, in each of an image having the provisional cross-point position, an image undergoing parallax adjustment, and an image after the parallax adjustment; and image processing means for administering a blur process to the subject to be blurred within the images.

In the present invention (the image processing apparatus as stated above and the image processing method to be hereinafter described), the first predetermined value, the second predetermined value and the third predetermined value including 0 may be all set to the same value or set to different values.

Note that health risks differ between stereoscopic display by a naked-eye viewing technique and stereoscopic display with a technique that uses glasses, according to the parallax amount at near side or at back side. In the case of stereoscopically displaying by the naked-eye viewing technique, the more forward a subject is projected, a greater burden is put on users' eyes. In the case of the technique that uses glasses, the more backward a subject is retreated, a greater burden is put on users' eyes. Thus, it is necessary to decide an appropriate processing according to the display technique.

In the image processing apparatus according to the present invention, it is preferable for the image processing means to perform the blur process on the subjects to be blurred at higher degrees as the absolute parallax value of the subjects to be blurred is increased.

Further, it is preferable for the parallax adjustment means to adjust parallax in not less than three stages. This three stages may be three frames in the case of moving images, for example.

In addition, the image processing apparatus according to the present invention further includes face detection means for detecting a face within images. In the parallax adjustment means, only a face may be a subject targeted for display position adjustment.

Further, in the parallax adjustment means, only the subjects that are within a predetermined range of the center of the image, may be the subjects targeted for display position adjustment.

Further, it is preferable for the parallax adjustment means to adjust parallax such that a position of the cross point is returned to an initial position, in the case that the subjects targeted for display position adjustment are moved out of the image.

The image processing method according to the present invention sets a predetermined point which corresponds to each other within a plurality of images with different viewpoints as a cross point and generates a stereoscopic image which is stereoscopically displayed on display means for stereoscopic display by performing parallax adjustment on the plurality of images such that parallax becomes 0 at the position of the cross point, and is characterized by including: calculating a parallax amount among the plurality of images for each subject within the images; identifying subjects having an absolute parallax value which exceeds a first predetermined amount as subjects targeted for display position adjustment, using a cross point provisionally set for the plurality of images as a reference; gradually adjusting parallax such that the absolute parallax value of the subjects targeted for display position adjustment does not exceed a second predetermined amount after adjustment; identifying subjects having an absolute parallax value which exceeds a third predetermined amount as subjects to be blurred, in each of an image representing a provisional cross-point position, an image being processed to a parallax adjustment, an image after parallax adjustment; and blurring the subjects to be blurred within images.

In the image processing method according to the present invention, it is preferable to perform the blur process on subjects to be blurred at higher degrees as the absolute parallax values of the subjects to be blurred is increased.

Further, faces within images may be detected, and only the faces may be set as subjects targeted for display position adjustment.

Further, only subjects that are within a predetermined range of the center of the image, may be subjects targeted for display position adjustment.

Further, in the case that subjects targeted for display position adjustment are moved out of the images, it is preferable for parallax to be adjusted such that the position of the cross point is returned to an initial position.

The image processing method according to the present invention may be provided as program for causing a computer to carry out the method.

According to the present invention, parallax amounts among a plurality of images are calculated for each subject within images. The subjects having an absolute parallax value which exceeds a first predetermined amount are identified as subjects targeted for display position adjustment, using a cross point provisionally set for the plurality of images as a reference, and parallax is gradually adjusted such that the absolute parallax value of the subjects targeted for display position adjustment does not exceed a second predetermined amount after adjustment so that the stereoscopic effect of stereoscopic images can be appropriately adjusted and the cross-point position is gradually changed, which can prevents users from feeling discomfort at the time of adjustment. Further, in such case, subjects having an absolute parallax value which exceeds a third predetermined amount are identified as subjects to be blurred, in each of an image representing a provisional cross-point position, an image being subjected to parallax adjustment, an image after parallax adjustment; and the subjects to be blurred are blurred in images so as to avoid directing a user' s attention toward the subject which are projected excessively forward. Thus, this can reduce the burden on users' eyes.

In this case, if the blur process is performed on subjects at a higher degree as an absolute parallax value of the subjects to be blurred is increased, users will not be caused to feel discomfort.

In addition, in the case that parallax is adjusted in not less than three stages, users will not be caused to feel discomfort.

Further, after detecting faces within images, if only the faces are specified as subjects targeted for display position adjustment; only the subjects within the predetermined range of the center of images are specified as subjects targeted for display position adjustment; or the subject that the users are highly interested in are specified as subjects targeted for display position adjustment; the stereoscopic effect of the stereoscopic images will not be excessively deteriorated.

Moreover, if parallax is adjusted such that the position of the cross point is returned to the initial position, in the case that subjects targeted for display position adjustment are shifted out of the image, there is no need to suppress even the stereoscopic effect of the images for which the stereoscopic effect no need to be suppressed. This can prevent the stereoscopic effect of stereoscopic images from being excessively deteriorated.

### BRIEF DESCRIPTION OF THE DRAWINGS

FIG. 1 is a schematic block diagram that illustrates an internal configuration of a polynocular camera, to which an image processing apparatus according to a first embodiment of the present invention is applied,

FIG. 2 is a schematic block diagram that illustrates the internal configuration of an image processing apparatus according to a first embodiment of the present invention,

FIG. 3 is a schematic block diagram that illustrates the configuration of a three dimensional processing unit of the polynocular camera,

FIG. 4A is a first flow chart that illustrates a process carried out at the time of adjusting a stereoscopic effect in the first embodiment,

FIG. 4B is a second flow chart that illustrates a process carried out at the time of adjusting a stereoscopic effect in the first embodiment,

FIG. 5 is a diagram that illustrates an example of a display image before adjustment,

FIG. 6 is a diagram that illustrates an example of a display image after adjustment,

FIG. 7 is a diagram for explaining steps of a blur process,

FIG. 8 is a diagram for explaining a relationship between a position of cutting out an image and a position of a subject in a depth direction in a stereoscopic image,

FIG. 9 is a diagram for explaining a timing of adjusting the stereoscopic effect,

FIG. 10 is a schematic block diagram that illustrates a three dimensional processing unit of a polynocular camera, to which an image processing apparatus according to a second embodiment of the present invention is applied,

FIG. 11A is a first flow chart that illustrates a process carried out at the time of adjusting the stereoscopic effect in the second embodiment,

FIG. 11B is a second flow chart that illustrates a process carried out at the time of adjusting the stereoscopic effect in the second embodiment,

FIG. 12 is a schematic block diagram that illustrates a three dimensional processing unit of a polynocular camera, to which an image processing apparatus according to a third embodiment of the present invention is applied,

FIG. 13A, is a first flow chart that illustrates a process carried out at the time of adjusting the stereoscopic effect in the third embodiment,

FIG. 13B is a second flow chart that illustrates a process carried out at the time of adjusting the stereoscopic effect in the third embodiment,

FIG. 14 is a diagram for explaining a process carried out at the time of adjusting the stereoscopic effect in the third embodiment,

FIG. 15 is a schematic block diagram that illustrates a three dimensional processing unit of a polynocular camera, to which an image processing apparatus according to a fourth embodiment of the present invention is applied,

FIG. 16A is a first flow chart that illustrates a process carried out at the time of adjusting the stereoscopic effect in the fourth embodiment,

FIG. 16B is a second flow chart that illustrates a process carried out at the time of adjusting the stereoscopic effect in the fourth embodiment.

### BEST MODE FOR CARRYING OUT THE INVENTION

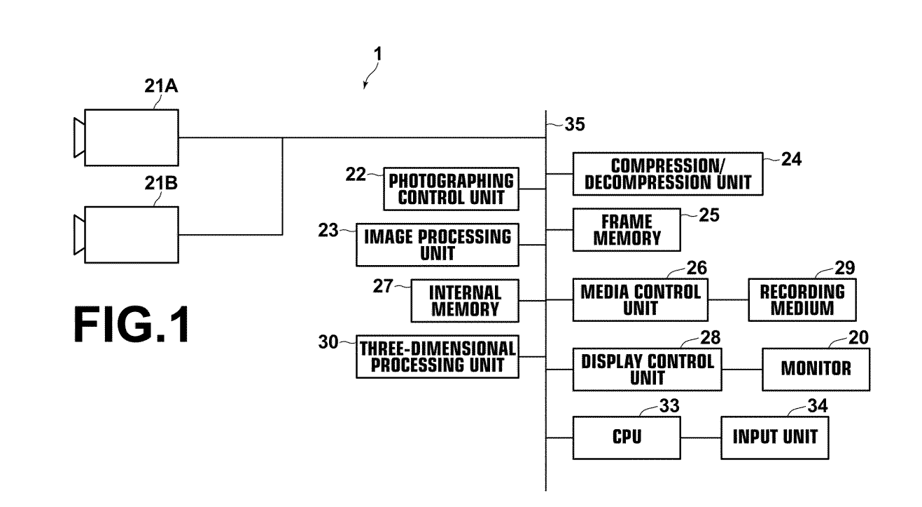

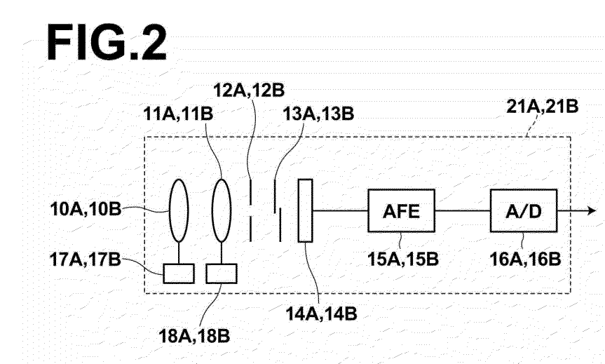

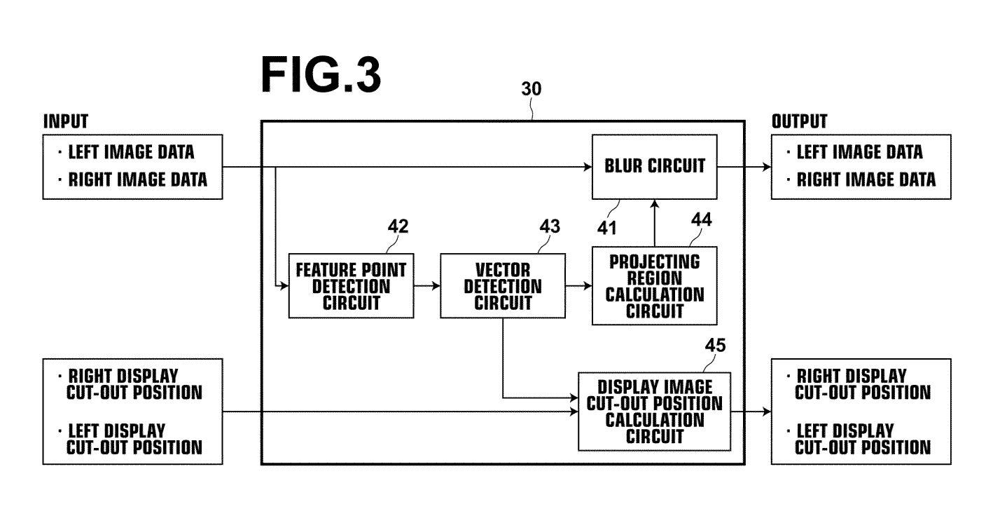

Hereinafter, embodiments of the present invention will be described with reference to the drawings. FIG. 1 is a schematic block diagram that illustrates the internal configuration of a polynocular camera, to which an image processing apparatus according to a first embodiment of the invention is applied. FIG. 2 is a schematic block diagram that illustrates the configuration of an imaging unit of the polynocular camera. FIG. 3 is a schematic block diagram that illustrates the configuration of a three dimensional processing unit of the polynocular camera.

As shown in FIG. 1, the polynocular camera 1 according to the first embodiment includes two imaging units 21A and 21B, a photographing control unit 22, an image processing unit 23, a compression/decompression unit 24, a frame memory 25, a media control unit 26, an internal memory 27, a display control unit 28, a three-dimensional processing unit 30 and a CPU 33. The imaging units 21A and 21B are placed to be able to photograph a subject with a predetermined baseline length and a convergence angle. It is assumed here that positions of the imaging units 21A and 21B in the vertical direction are the same.

FIG. 2 illustrates the configuration of the imaging units 21A and 21B. As shown in FIG. 2, the imaging units 21A and 21B include focusing lenses 10A and 10B, zooming lenses 11A and 11B, aperture diaphragms 12A and 12B, shutters 13A and 138, CCDs 14A and 14B, analog front ends (AFE) 15A and 15B and A/D converting units 16A and 16B, respectively. The imaging units 21A and 21B further include focusing lens driving units 17A and 17B for driving the focusing lenses 10A and 10B and zooming lens driving units 18A and 18B for driving the zooming lenses 11A and 11B.

The focusing lenses 10A and 10B are used to focus on the subject, and are movable along the optical axis directions by the focusing lens driving units 17A and 17B, each of which is formed by a motor and a motor driver. The focusing lens driving units 17A and 17B control the movement of the focusing lenses 10A and 10B based on focal position data which is obtained through AF processing, which will be described later, carried out by the imaging control unit 22.

The zooming lenses 11A and 11B are used to achieve a zooming function, and are movable along the optical axis directions by the zooming lens driving units 18A and 18B, each of which is formed by a motor and a motor driver. The zooming lens driving units 18A and 18B control the movement of the zooming lenses 11A and 11B based on zoom data obtained at the CPU 33 upon operation of a zoom lever, which is included in an input unit 34.

The aperture diameters of the aperture diaphragms 12A and 12B are adjusted by an aperture diaphragm driving unit (not shown) based on aperture value data obtained through AE processing carried out by the imaging control unit 22.

The shutters 13A and 13B are mechanical shutters, and are driven by a shutter driving unit (not shown) according to a shutter speed obtained through the AE processing.

Each of the CCDs 14A and 14B includes a photoelectric surface, on which a large number of light-receiving elements are arranged two-dimensionally. A light image of the subject is focused on each photoelectric surface and is subjected to photoelectric conversion to obtain an analog imaging signal. Further, a color filter formed by regularly arrayed R, G and B color filters are disposed on the front side of each CCD 14A, 14B.

The AFEs 15A and 15B process the analog imaging signals fed from the CCDs 14A and 14B to remove noise from the analog imaging signals and adjust the gain of the analog imaging signals (this operation is hereinafter referred to as “analog processing”).

The A/D converting units 16A and 16B convert the analog imaging signals, which have been subjected to the analog processing by the AFEs 15A and 15B, into digital imaging signals. The images represented by digital image data acquired by the imaging units 21A and 21B are referred to as an image GL and an image GR, respectively.

The imaging control unit 22 includes an AF processing unit and an AE processing unit (not shown). When a release button included in the input unit 34 is half-pressed, the imaging units 21A and 21B acquire preliminary images. Then, the AF processing unit determines focused areas and focal distances for the lenses 10A and 10B based on the preliminary images, and outputs the information to the imaging units 21A and 21B. The AE processing unit determines an exposure value based on a brightness evaluation value, which is calculated from brightness values of the preliminary images, and further determines an aperture value and shutter speed based on the exposure value to output the information to the imaging units 21A and 21B.

When the release button is fully pressed, the imaging control unit 22 instructs the imaging units 21A and 21B to carry out actual imaging to acquire actual images of the images GL and GR. It should be noted that, before the release button is operated, the imaging control unit 22 instructs the imaging units 21A and 21B to successively acquire live view images at a predetermined time interval (for example, at an interval of 1/30 seconds) for checking imaging ranges of the imaging units 21A and 21B.

The image processing unit 23 administers image processing, such as white balance adjustment, tone correction, sharpness correction and color correction, to the digital image data of the images GR and GL acquired by the imaging units 21A and 21B.

The compression/decompression processing unit 24 administers compression processing according to a certain compression format, such as JPEG, to the image data representing a three-dimensional image for three-dimensional display, which is generated, as will be described later, from the actual images of the images GL and GR processed by the image processing unit 23, and generates a three-dimensional image file for three-dimensional display. The three-dimensional image file contains the image data of the images GL and GR and the image data of the three-dimensional image. A tag storing associated information, such as photographing time and date, is added to the image file, based, for example, on the Exif format.

The frame memory 25 provides a workspace for various processes, including the processing by the image processing unit 23, administered to the image data representing the images GL and GR acquired by the imaging units 21A and 21B.

The media control unit 26 accesses a recording medium 29 and controls writing and reading of the three-dimensional image file, etc., into and from the recording medium 29.

The internal memory 27 stores various constants to be set within the polynocular camera 1, a program executed by the CPU 33, etc.

The display control unit 28 causes the images GL and GR stored in the frame memory 25 during imaging to be displayed for two-dimensional viewing on the monitor 20, or causes the images GL and GR recorded in the recording medium 29 to be displayed for two-dimensional viewing on the monitor 20. Further, the display control unit 28 can cause the images GL and GR, which have been subjected to the three-dimensional processing, as will be described later, to be displayed for three-dimensional viewing on the monitor 20, or can cause the three-dimensional image recorded in the recording medium 29 to be displayed for three-dimensional viewing on the monitor 20. Switching between the two-dimensional display and the three-dimensional display may automatically be carried out, or may be carried out according to instructions from the photographer via the input unit 34. During the three-dimensional display, live view images of the images GL and GR are displayed for three-dimensional viewing on the monitor 20 until the release button is pressed.

The three-dimensional processing unit 30 applies the three-dimensional processing to the images GR and GL for the three-dimensional display of the images GR and GL on the monitor 20. The three-dimensional display technique used in this embodiment may be any known technique. For example, the images GR and GL may be displayed side by side to achieve stereoscopic viewing by parallel viewing with naked eyes, or a lenticular system may be used to achieve the three-dimensional display, in which a lenticular lens is attached on the monitor 20, and the images GR and GL are displayed at predetermined positions on the display surface of the monitor 20 so that the images GR and GL are respectively viewed by the left and right eyes. Further, a scanning backlight system may be used, which achieves the three-dimensional display by optically separating the optical paths of the backlight of the monitor 20 correspondingly to the left and right eyes in an alternate manner, and alternately displaying the images GR and GL on the display surface of the monitor 20 according to the separation of the backlight to the left or the right.

The monitor 20 is modified according to the type of the three-dimensional processing carried out by the three-dimensional processing unit 30. For example, if the three-dimensional display is implemented with a lenticular system, a lenticular lens is attached on the display surface of the monitor 20. If the three-dimensional display is implemented with a scanning backlight system, an optical element for changing the directions of the light beams from the left and right images is attached on the display surface of the monitor 20.

It should be noted that in the description of the preferred embodiments, the case where a lenticular system is adopted as a stereoscopic display technique will be described.

Accordingly, the three-dimensional processing unit 30 sets a predetermined point within each of the images GR, GL as a cross point and performs a process for cutting out a display range on the monitor 20 from the images GR and GL such that the cross points within the respective images GR, GL are displayed at the same position on the monitor 20, in order to three dimensionally display the images GR, GL on the monitor 20.

As shown in FIG. 3, the three-dimensional processing unit 30 includes a blur circuit 41, a feature point detection circuit 42, a vector detection circuit 43, a projecting region calculation circuit 44, and a display image cut-out position calculation circuit 45. The blur circuit 41 administers a blur process to the subjects to be blurred within the images GR, GL. The feature point detection circuit 42 detects a feature point from either one of the images GR, GL and detects a corresponding point from the other image, which corresponds to the feature point in the one image. The vector detection circuit 43 calculates a vector between each feature point and a corresponding point corresponding thereto. The projecting region calculation circuit 44 identifies subjects to be projected forward from the cross point within images being processed as subjects to be blurred. The display image cut-out position calculation circuit 45 adjusts a position at which a display range is gradually cut out from the images GR, GL such that a subject targeted for display position adjustment is caused to be at the cross point position by identifying subjects to be projected forward from the cross point within images being processed as subjects targeted for display position adjustment.

The CPU 33 controls the various units of the polynocular camera 1 according to signals inputted via the input unit 34, which includes the release button, the arrow key, etc.

The data bus 35 is connected to the various units forming the polynocular camera 1 and the CPU 33 for communication of various data and information in the polynocular camera 1.

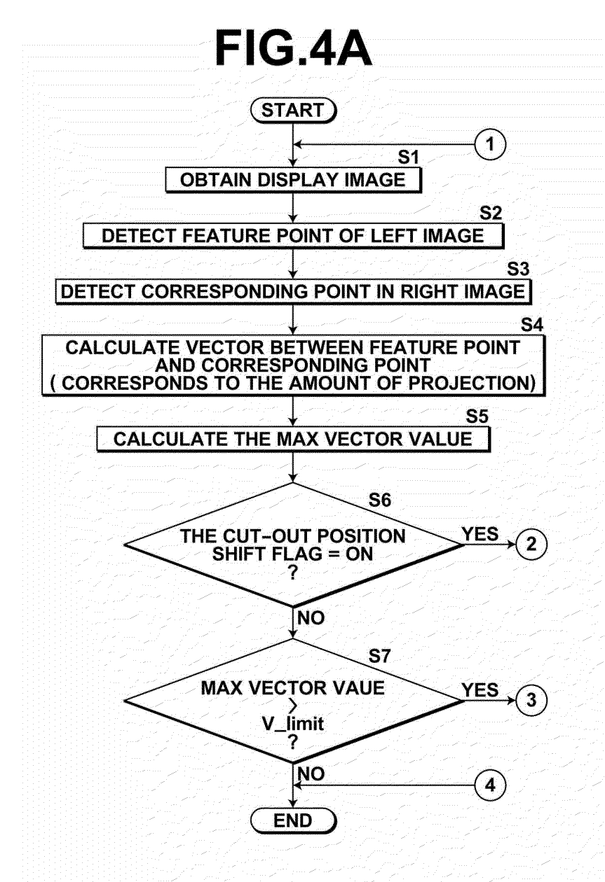

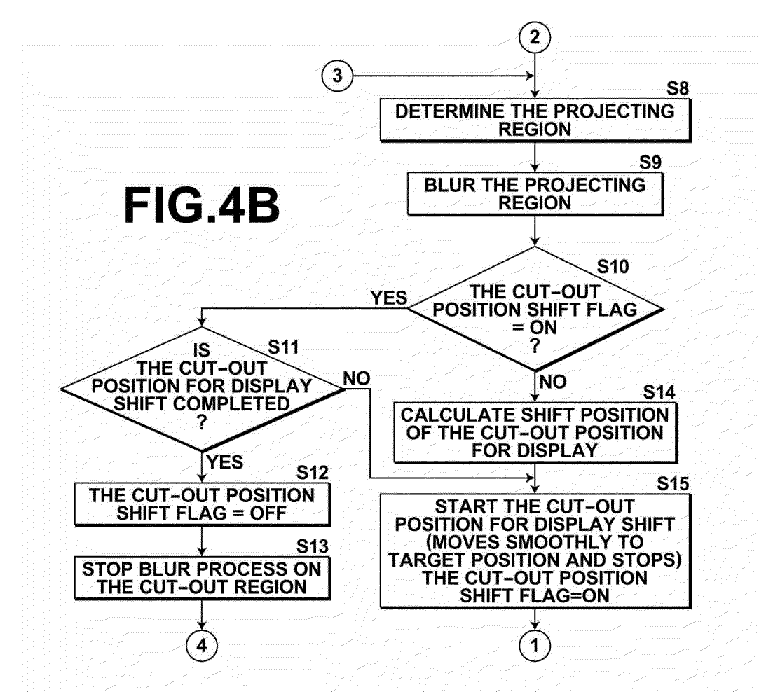

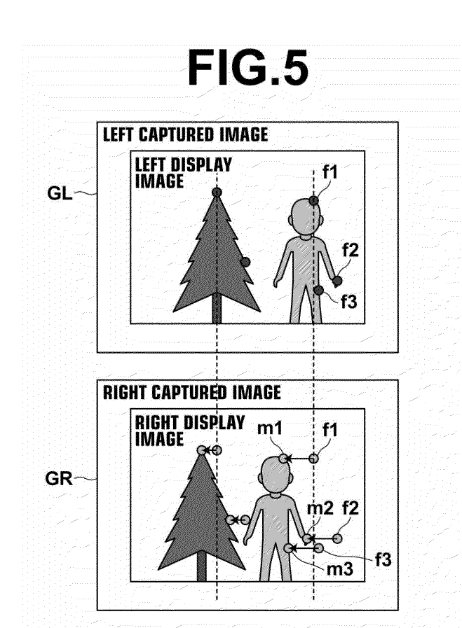

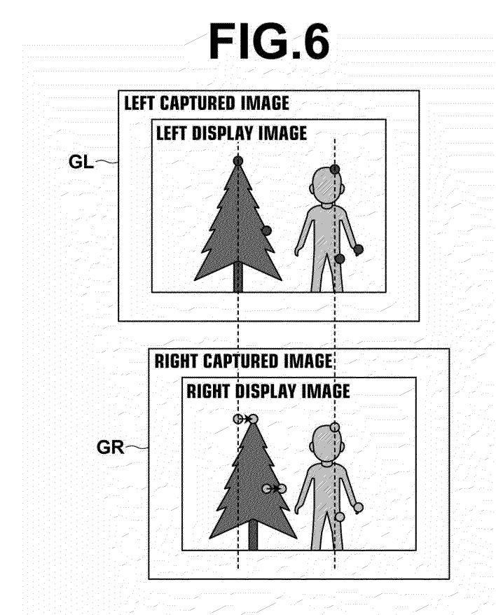

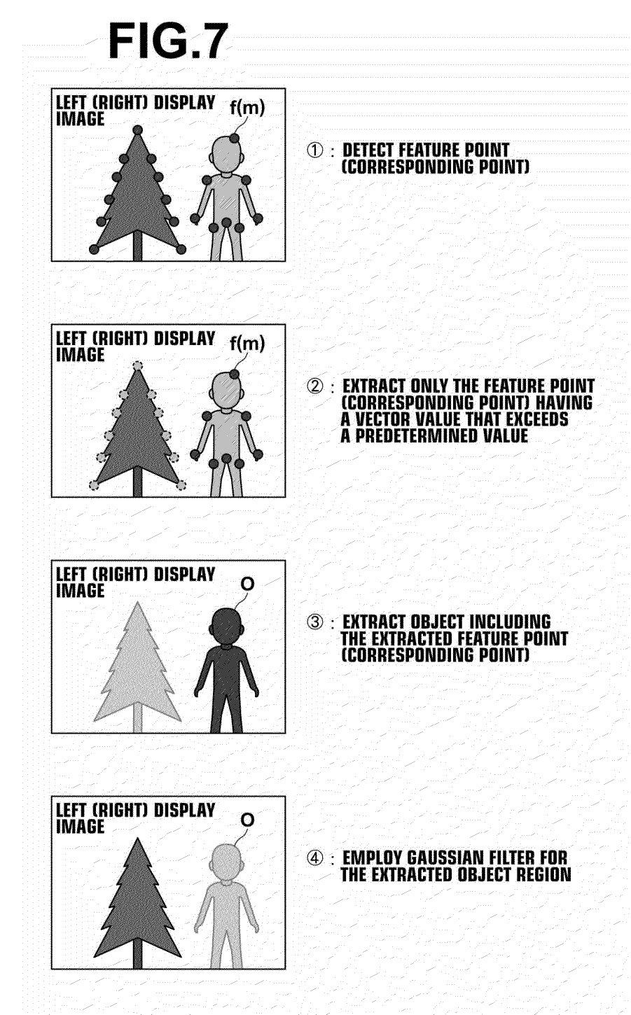

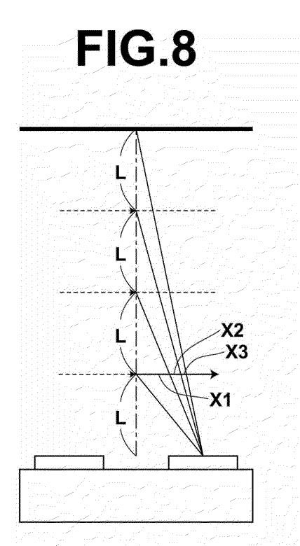

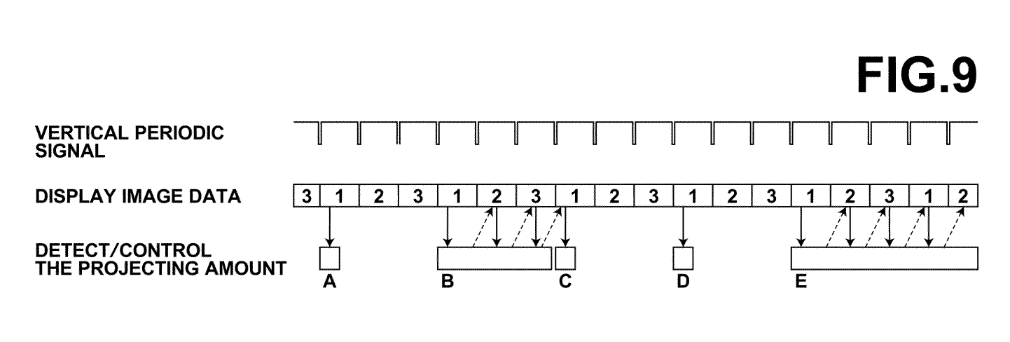

Next, a process carried out in the first embodiment will be described. FIG. 4 is a flow chart that illustrates the process carried out at the time of adjusting a stereoscopic effect in the first embodiment. FIG. 5 is a diagram that illustrates an example of a display image before adjustment. FIG. 6 is a diagram that illustrates an example of a display image after adjustment. FIG. 7 is a diagram for explaining the steps of a blur process. FIG. 8 is a diagram for explaining a relationship between a position of cutting out an image and a position of a subject in a depth direction in a stereoscopic image. FIG. 9 is a diagram for explaining a timing of adjusting the stereoscopic effect.

A polynocular camera 1 according to the first embodiment is characterized in that all the subjects that are located anteriorly away from the provisional cross point position are identified as subjects targeted for display position adjustment, and a cross point position is gradually adjusted from a provisional cross point position to a cross point position after adjustment in a depth direction of a subject such that the subjects targeted for display position adjustment do not move forward away from the cross point position after adjustment.

For example, when displaying stereoscopic images such as live view images, still images and through-the-lens images on the monitor 20, two images GR, GL for generating stereoscopic images are obtained at first (step S1). It should be noted that the images GR, GL are attached with cut-out position shift flag information which is set OFF in an initial state. Further, a cut-out position of a display area of each of the images GR, GL is determined based on the state in which the center of each of the images GR, GL is set as a cross point position which is a provisional position (the initial state).

Next, as shown in FIG. 5, either one of the images is used as a reference to detect feature points f from the reference image (step S2). In the present embodiment, the left image GL is assumed to be a reference image. Then, corresponding points m corresponding to the feature points f within the reference image are detected from the other image (the right image GR, in the present embodiment) (step S3). Then, vector values between each feature point f and a corresponding point m corresponding thereto is calculated (step S4), and a feature point having the greatest vector value is extracted from thereamong (step S5).

Next, a determination is made as to whether each cut-out position shift flag of the images GR, GL is ON (step S6). If the result of the determination is negative, a determination is made as to whether the greatest vector value which has been detected in step S5 exceeds a predetermined value (V_limit) (step S7). In the present embodiment, V_limit is assumed to be 0. Thus, it is assumed here that subjects which is located even slightly forward from the cross point are subjects which are projected excessively forward.

The result of the initial determination in step S6 is always negative because the initial state of the cut-out position shift flag is OFF, thereby the process moves to step S7. If the result of the determination in step S7 is negative, the process is terminated.

In the case that the result of the determination in step S7 is affirmative, as shown in FIG. 7, the feature points f and corresponding points m are detected from the images GR, GL, and then only the feature points f and corresponding points m having a vector value which exceeds a predetermined value are extracted to extract objects o (subjects to be blurred) including the extracted feature points f/corresponding points m (step S8). The predetermined value may be the same as or different from that of step S7. However, it is assumed here that the predetermined value is the same value (V_limit) in the present embodiment. Further, regarding a method for extracting objects, various existing methods may be employed.

Next, the extracted object o is subjected to the blur process (step S9). Here, the blur process may employ filters such as a Gaussian filter, or may use a simple averaging process.

In the present embodiment, as an example, a case of employing a Gaussian filter will be described. In the case of employing a two-dimensional Gaussian filter, a pixel (Xa, Yb) can be calculated by formula (1) shown below:

$${p}_{out} ( {x}_{a} , {x}_{b} ) = \frac{1}{{N}^{2}} {\sum }_{i} {\sum }_{j} exp ( - \frac{{( {x}_{i} - {x}_{a} )}^{2}}{2 {σ}^{2}} ) \cdot exp ( - \frac{{( {y}_{i} - {y}_{b} )}^{2}}{2 {σ}^{2}} ) \cdot {p}_{i n} ( {x}_{i} , {y}_{j} ) \qquad ( 1 )$$

In this case,
P out represents pixel output after filtering
P in represents pixel output before filtering
N represents a normalization constant
i represents the number of surrounding pixel sampling
j represents the number of surrounding pixel sampling
σ² represents dispersion.

Here, the amount of blur will increase as dispersion σ² becomes large. Thus, the amount of blur can be adjusted by performing controls such as increasing dispersion σ² according to the amount that a subject projects forward from the cross point. The details of this process will be described later in the description of step S15.

Next, a determination is made as to whether each cut-out position shift flag of the images GR, GL is ON (step S10). If the result of the determination is negative, the shift amount of the cut-out position from a current cut-out position (the provisional position in the first process cycle) to a cut-out position after adjustment is calculated (step S14). The result of the initial determination in step S10 is always negative because the initial state of the cut-out position shift flag is OFF, thereby the process inevitably moves to step S14.

In this case, the cut-out position after adjustment may be set to any position at which the amount that a subject projects forward from the cross point becomes small. However, it is preferable for the cut-out position after adjustment to be a cut-out position at which the feature point having the greatest vector value that has been detected in step S5 at first is set to a cross point position, i.e., a position at which no subject is ultimately displayed forward of the cross point position.

However, in the case that the cut-out position is shifted in a direction where the amount that a subject projects forward is reduced, the background will be caused to move backward further, which causes the eyes to open wide depending on display monitors. This increases the risk of strabismus for children who view such an image. It is preferable for even a large monitor of 60 inches, for example, that the shift amount of the cut-out position is reduced to such degree that no risk of strabismus arise.

In the case that a vector limit for avoiding strabismus is set to V_back_limit (negative value) in step S4, when the shift amount of the cut-out position satisfies formula (4) shown below, it is expressed by the following formula (5). When the shift amount of the cut-out position satisfies formula (4) shown below, it is expressed by the following formula (6).

Vector MIN value−Vector MAX value≦V_back_limit (4)

The shift amount of cut-out position=Vector MAX value+(Vector MIN value−Vector MAX value−V_back_limit) (5)

The shift amount of cut-out position=Vector MAX value (6)

Next, the calculated shift amount of the cut-out position in step S14 is divided into a plurality of portions, and the cut-out position is shifted by one step for each process. The amount that subjects project forward can be suppressed by shifting the display area within the right image GR in the left direction while keeping the display area within the left image GL fixed, by shifting the display area within the left image GL in the right direction while keeping the display area within the right image GR fixed, or by shifting the display area within the left image GL in the right direction and shifting the display area within the right image GR in the left direction at the same time. In contrast, the amount that subjects project forward can be increased by shifting each display area of the images GR, GL in a direction opposite to the above directions. In addition, if each cut-out position shift flag of the images GR, GL is OFF, these flags are changed to ON (step S15).

Here, the number of partitions of the shift amount of cut-out position is not especially limited. The present embodiment will be described assuming that the number of partitions is 3. Further, the shift amount of cut-out position may be equally divided or may be divided into different amounts.

However, as shown in FIG. 8, as a subject moves from forward to backward, a change in cut-out position (a change in the display positions of right and left) will have a greater influence on a change in the amount that subjects project forward from the cross point. Therefore, in the case that the shift amount of cut-out position is equally divided, the subject will seem to move to the target position while accelerating.

Thus, there is also a method for changing cut-out positions such that a subject moves to the target position at a constant speed when moving from forward to backward. For example, a case that a subject is at a position where the ratio of the distance between the subject and the cross point to the distance between the subject and the camera is 3:1 will be considered. In the case that the above shift amount of cut-out position is divided into three, if the divided shift amounts of cut-out positions X1, X2, X3 are gradually changed according to the rate expressed by formula (2) shown below, the subject will seem to move to the target position at a constant speed:

$$X 1 \text{:} X 2 \text{:} X 3 = \frac{1}{1 \times 2} \text{:} \frac{1}{2 \times 3} \text{:} \frac{1}{3 \times 4} = 6 \text{:} 2 \text{:} 1 \qquad ( 2 )$$

It should be noted that cases in which the amount is divided into a plurality of portions other than three portions can be considered, depending on the relationship between the distance from the subject to the cross point and the distance from the subject to the camera. The same basically also applies to such cases. Thus, the amount may be gradually changed according to the rate expressed by formula (3) shown below:

$$X 1 \text{:} X 2 \text{:} X 3 \text{:} … X n = \frac{1}{1 \times 2} \text{:} \frac{1}{2 \times 3} \text{:} \frac{1}{3 \times 4} \text{:} … \frac{1}{n \times ( n + 1 )} \qquad ( 3 )$$

In addition, a dividing method can be changed by judging the relationship between the distance from a subject to the cross point and the distance from the subject to the camera according to a vector value between each feature point f and a corresponding point m corresponding thereto.

Further, the determined shift amount of cut-out position for each stage will be closely related to a blur process in step S9 of the second and subsequent cycle.

In optical imaging, it has been known that in the case that a subject moves away from a focus position by a distance L, the blur amount is substantially proportional to 1/L. The blur amount is determined based on the distance from a focal plane, and the distance from a focal plane is substantially proportional to the reciprocal of subject distance (Newton's formula). Thus, if the degree of the blur process is changed in accordance with a change in the amount of projection described above, natural images can be created for users.

In this case, the degree of the blur process is adjusted by σ. For example, in the case that the shift amount of cut-out position is equally divided in three stages, o may be set as shown below. It should be noted that L is the shift amount of a subject for each stage.
before shifting: σ=⅓ L×k
X1 after shifting: σ=½ L×k
X2 after shifting: σ=1/L×k
X3 after shifting: σ=∞ (i.e., no blur process is performed)

When step S15 is completed, the process returns to step S1 again. Thereafter, the same steps as those in the first cycle will be carried out. However, since the cut-out position shift flag is ON in the second and subsequent cycles, the result of the determination in step S6 will be different from that in the first cycle, thereby the process directly moves to step S8. Moreover, the result of the determination instep S10 will also be different from that in the first cycle, thereby the process moves to step S11.

In step S11, a determination is made as to whether the shift of cut-out position for display is completed. If the result of the determination is negative, the process moves to step S15 to shift the cut-out position by one step and then returns to step S1 again.

In the case that the result of the determination in step S11 is affirmative, i.e., as shown in FIG. 6, the feature point having the greatest vector value which has been detected in step S5 at first, is set as the cross point position, each cut-out position shift flag of the images GR, GL will be changed to OFF (step S12), and if the blur process is completed, the blur process will be suspended (step S13), thereby terminating the process.

Regarding the timing of carrying out the above process, as shown in FIG. 9, when displaying the stereoscopic images such as live view images, still images or through-the-lens images on the monitor 20, confirmation is regularly made as to steps S1 through S7 for each set of predetermined numbers of frames (three frames as one example in FIG. 9). In the case that no subjects are projected excessively forward, the process is terminated (e.g., A, C, D in FIG. 9). In the case that any subject is projected excessively forward, the whole process is carried out from steps S1 through S15 (e.g., B, E in FIG. 9). It should be noted that in the case that the interval between the confirmation processes is longer than the amount of time required for the entire process, no overlapping process is carried out (e.g., E in FIG. 9).

With the above configuration, the stereoscopic effect of the stereoscopic images can be appropriately adjusted, and the cross point is gradually shifted, which can prevent users from feeling discomfort during adjustment. Further, when the cross point is gradually shifted, the subjects to be blurred, which are forward away from the cross point position of each image, are blurred within images so as to avoid directing a user's attention toward the subjects which are projected excessively forward from the cross point position. Thus, this can reduce the burden on users' eyes.

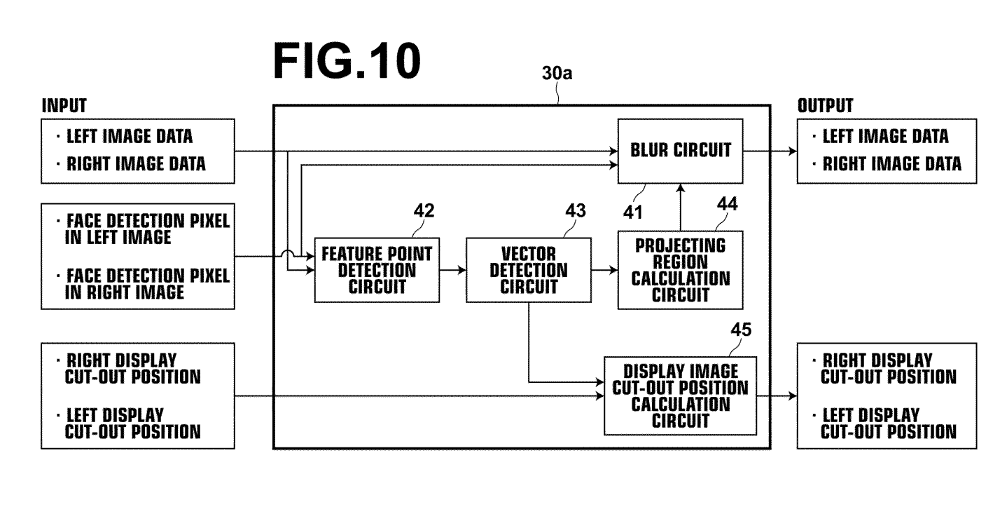

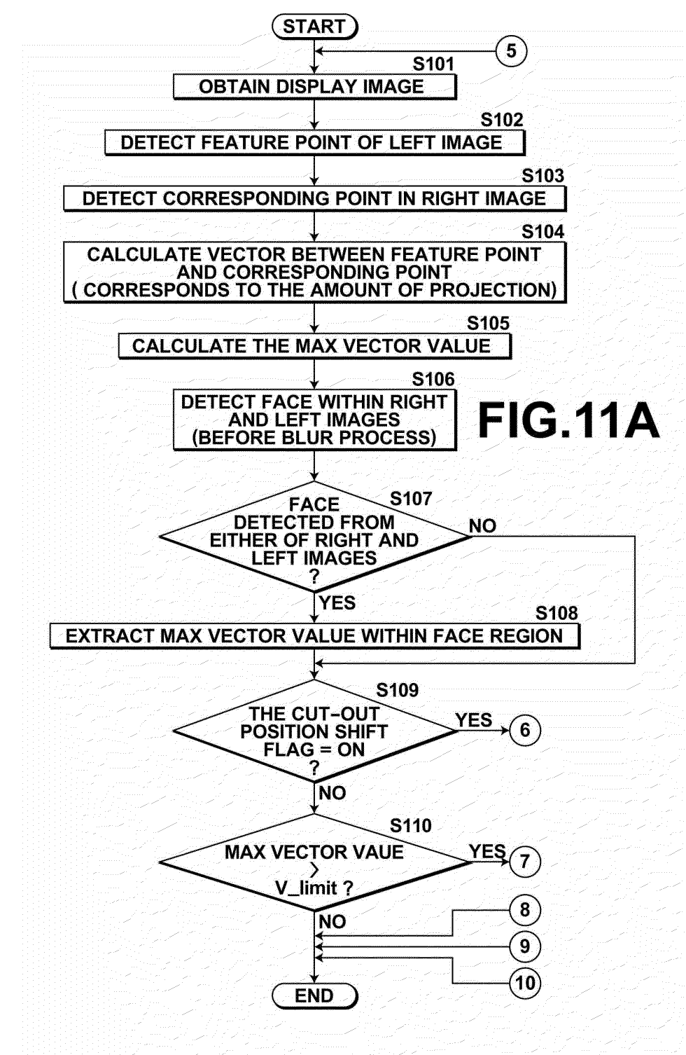

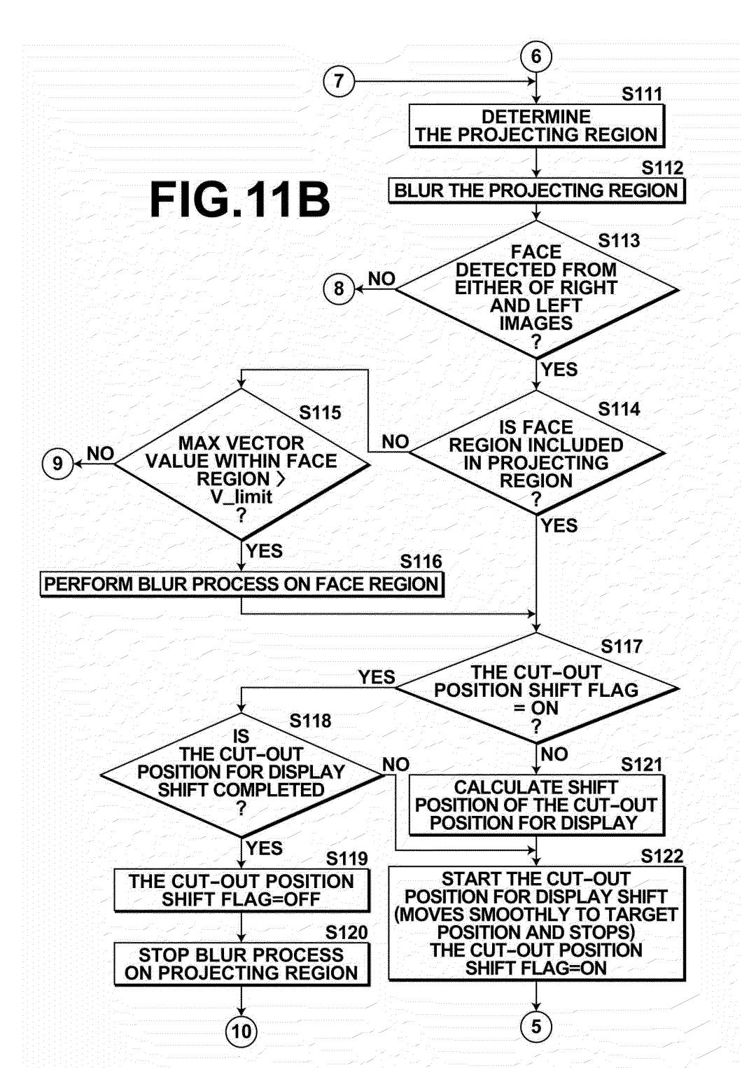

Next, a second embodiment of the present invention will be described. It should be noted that a polynocular camera, to which an image processing apparatus according to the second embodiment of the invention is applied, has substantially the same configuration as that of a polynocular camera 1 according to the first embodiment, and therefore detailed descriptions of the same constituent elements will be omitted here. FIG. 10 is a schematic block diagram that illustrates a three dimensional processing unit of a polynocular camera, to which an image processing apparatus according to a second embodiment of the present invention is applied. FIG. 11 is a flow chart that illustrates a process carried out at the time of adjusting the stereoscopic effect in the second embodiment.

A polynocular camera according to the second embodiment is mainly characterized in that only faces are specified as subjects targeted for display position adjustment among the subjects located forward away from the provisional cross point position, and the cross point position is gradually adjusted from the provisional cross point to the cross point position after adjustment such that the subjects targeted for display position adjustment do not move forward away from the cross point position after adjustment.

The polynocular camera according to the second embodiment differs from the polynocular camera according to the first embodiment in the configuration of the three-dimensional processing unit and in that the polynocular camera according to the second embodiment includes a face detecting means for detecting faces from the images GR, GL.

As shown in FIG. 10, the three-dimensional processing unit 30a of the present embodiment includes a blur circuit 41, a feature point detection circuit 42, a vector detection circuit 43, a projecting region calculation circuit 44, and a display image cut-out position calculation circuit 45. The blur circuit 41 administers a blur process to the subjects to be blurred within the images GR, GL. The feature point detection circuit 42 detects a feature point from either one of the images GR, GL and detects a corresponding point from the other image, which corresponds to the feature point in the one image. The vector detection circuit 43 calculates a vector between each feature point and a corresponding point corresponding thereto. The projecting region calculation circuit 44 identifies subjects to be projected forward from the cross point within images being processed as subjects to be blurred. The display image cut-out position calculation circuit 45 adjusts a position at which a display range is gradually cut out from the images GR, GL such that a subject targeted for display position adjustment is caused to be at the cross point position by identifying subjects to be projected forward from the cross point within images being processed as subjects targeted for display position adjustment.

Next, a process carried out in the second embodiment will be described.

For example, when displaying stereoscopic images such as live view images, still images and through-the-lens images on the monitor 20, two images GR, GL for generating stereoscopic images are obtained at first (step S101). It should be noted that the images GR, GL are attached with cut-out position shift flag information that is set OFF in an initial state. Further, a cut-out position of a display area of each of the images GR, GL is determined based on the state in which the center of each of the images GR, GL is set as a cross point position which is a provisional position (the initial state).

Next, either one of the images is used as a reference to detect feature points f from the reference image (step S102). In the present embodiment, the left image GL is assumed to be a reference image. Then, corresponding points m corresponding to the feature points f within the reference image are detected from the other image (the right image GR in the present embodiment) (step S103). Then, vector values between each feature point f and a corresponding point m corresponding thereto is calculated (step S104), and a feature point having the greatest vector value is extracted from among the feature points (step S105).

Next, a process for detecting faces from the images GR, GL is carried out (step S106), and a determination is made as to whether faces are detected from either of the images GR, GL (step S107). In the case that the result of the determination is affirmative, the feature point having the greatest vector value between each feature point f and a corresponding point m corresponding thereto within face areas is extracted (step S108). In the case that the result of the determination is negative, step S108 is skipped, and thereby the process moves directly to step S109.

Next, a determination is made as to whether each cut-out position shift flag of the images GR, GL is ON (step S109). If the result of the determination is negative, a determination is made as to whether the greatest vector value which has been detected in step S105 exceeds a predetermined value (V_limit) (step S110). In the present embodiment, V_limit is assumed to be 0. Thus, it is assumed here that subjects which are located even slightly forward from the cross point are subjects which are projected excessively forward.

The result of the initial determination in step S109 is always negative because the initial state of the cut-out position shift flag is OFF, and thereby the process moves to step S110. If the result of the determination in step S110 is negative, the process is terminated.

In the case that the result of the determination in step S110 is affirmative, the feature points f and corresponding points m of the subjects other than faces are detected from the images GR, GL, and then only the feature points f and corresponding points m having a vector value which exceeds a predetermined value are extracted to extract objects o (subjects to be blurred) including the extracted feature points f/corresponding points m (step S111). The predetermined value may be the same as or different from that of step S110. However, it is assumed here that the predetermined valued is the same value (V_limit) in the present embodiment. Further, regarding a method for extracting objects, various existing methods may be employed.

Next, the extracted object o is subjected to the blur process (step S110). Here, the blur process may employ filters such as a Gaussian filter, or may use a simple averaging process. The details of the blur process are the same as those the first embodiment described above.

Next, a determination is made as to whether faces are detected from either of the images GR, GL (step S113). In the case that the result of the determination is negative, the process is terminated. The result of the determination in step S113 is affirmative, a determination is made as to whether faces are included in the subjects to be blurred, which have been extracted in step S111 (step S114).

In the case that the result of the determination in step S114 is negative, a determination is made as to whether the greatest vector value within the face area, which has been extracted in step S108, exceeds a predetermined value (V_limit) (step S115). In the case that the result of the determination is negative, the process is terminated. In the case that the result of the determination in step S115 is affirmative, a blur process is administered to the face area (step S116). The details of this blur process conform to those of steps S111 and S112. Further, if the result of the determination in step S114 is affirmative, the process directly moves to step S117.

Next, a determination is made as to whether each cut-out position shift flag of the images GR, GL is ON (step S117). If the result of the determination is negative, the shift amount of the cut-out position from a current cut-out position (the provisional position in the first process cycle) to a cut-out position after adjustment is calculated (step S121). The result of the initial determination in step S117 is always negative because the initial state of the cut-out position shift flag is OFF, thereby the process inevitably moves to step S121. In this case, the cut-out position after adjustment may be set to any position at which the projecting amount of the face region forward from the cross point becomes small. However, it is preferable for the cut-out position after adjustment to be a cut-out position at which the feature point having the greatest vector value within the face area, that has been detected in step S108 at first, is set to a cross point position, i.e., a position at which no subject is ultimately displayed forward of the cross point position. The details of the cut-out position after adjustment other than the above are the same as those of the first embodiment described above.

Next, the shift amount of the cut-out position which has been calculated in step S117 is divided into a plurality of portions, and the cut-out position is shifted by one step for each process. In addition, if each cut-out position shift flag of the images GR, GL is OFF, these flags are changed to ON (step S122). In this case, the division number and the division of the shift amount of cut-out position are the same as those of the first embodiment described above.

When step S122 is completed, the step returns to step S101 again. Hereafter, the same processes as those in the first cycle will be carried out. However, since the cut-out position shift flag is ON in the second and subsequent cycles, the result of the determination in step S109 will be different from that in the first cycle, thereby the process directly moves to step S111. Moreover, the result of the determination in step S117 will also be different from that in the first cycle, thereby the process moves to step S118.

In step S118, a determination is made as to whether the shift of cut-out position for display is completed. If the result of the determination is negative, the process moves to step S112 to shift the cut-out position by one step and then returns to step S101 again.

In the case that the result of the determination in step S118 is affirmative, i.e., the feature point having the greatest vector value which has been detected in step S105 at first, is set as the cross point position, each cut-out position shift flag of the images GR, GL will be changed to OFF (step S119), and if the blur process is being executed, the blur process will be suspended (step S120), thereby terminating the process.

The timing of the above processes is the same as that in the first embodiment described above.

Even when the above configuration is adopted, the same advantageous effects as those obtained by the first embodiment described above can be obtained. Basically, it is often the case that the main subject is a face, even when an area, in which the subjects other than faces are projected forward, is large; the user is considered to be unlikely to pay attention on the area. Thus, in the present embodiment, in the case that the subjects other than faces are projected forward, only the blur process is carried out thereon. This can reduce the burden on user's eyes, and prevent the stereoscopic effect of the stereoscopic images from being excessively deteriorated.

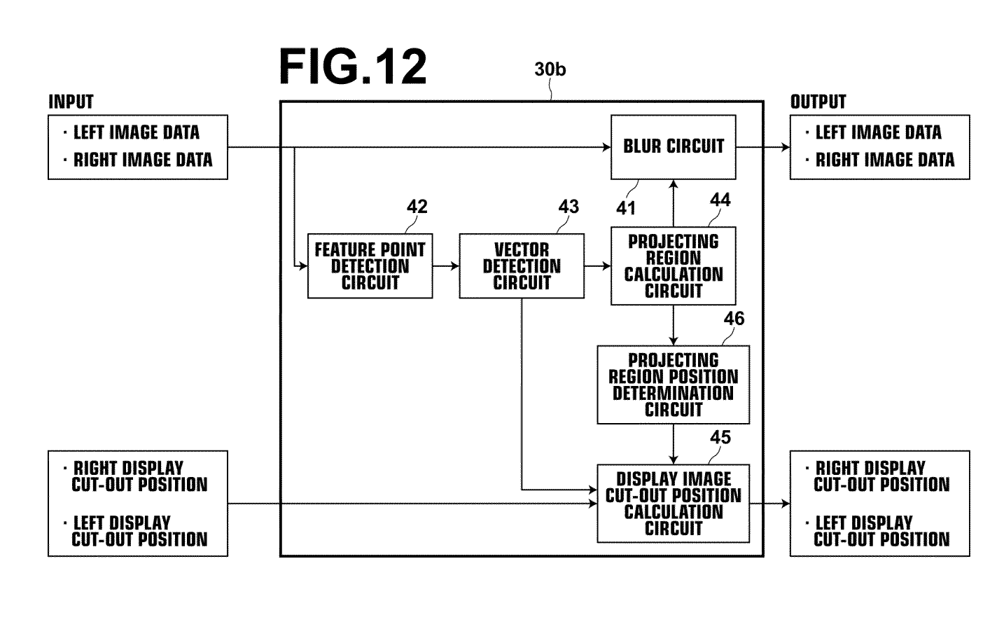

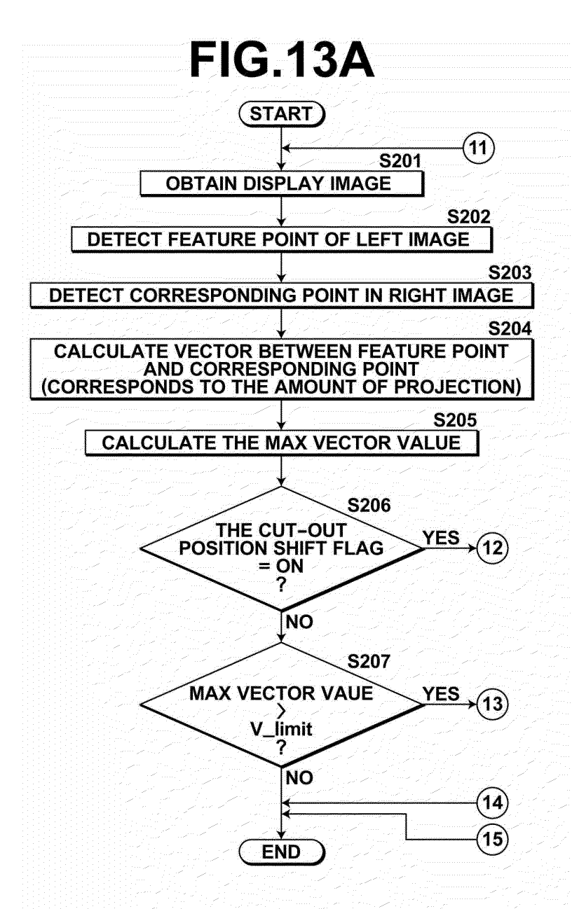

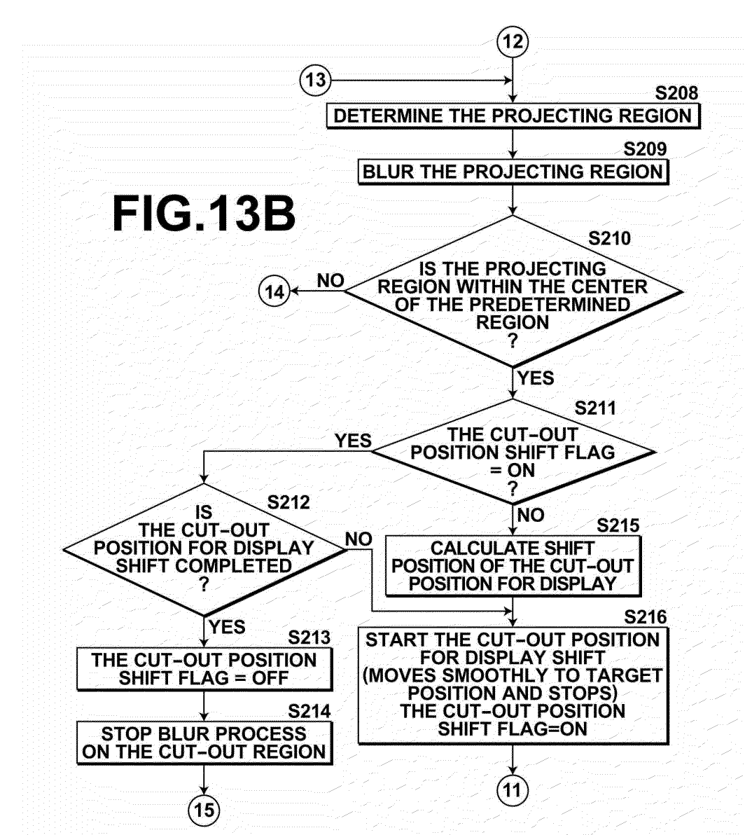

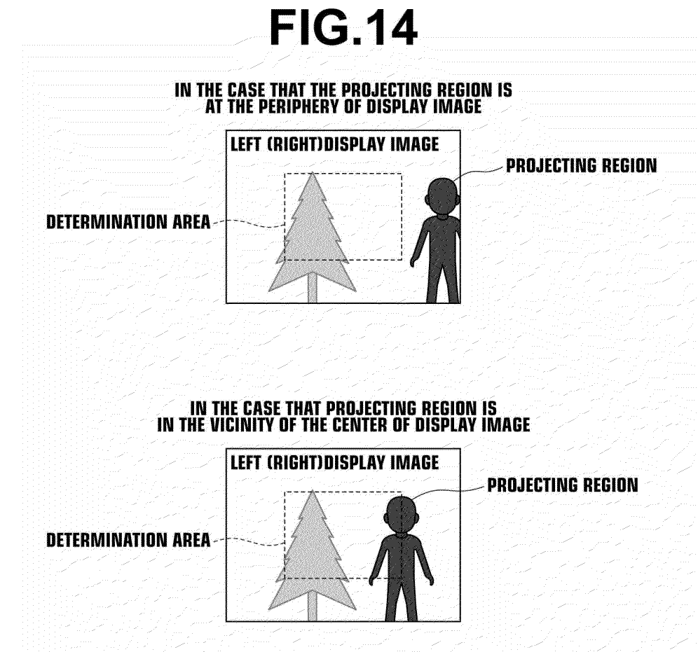

Next, a third embodiment of the present invention will be described. It should be noted that a polynocular camera, to which an image processing apparatus according to the third embodiment of the invention is applied, has substantially the same configuration as that of a polynocular camera 1 according to the first embodiment, and therefore detailed descriptions of the same constituent elements will be omitted here. FIG. 12 is a schematic block diagram that illustrates a three dimensional processing unit of a polynocular camera, to which an image processing apparatus according to a third embodiment of the present invention is applied. FIG. 13 is a flow chart that illustrates a process carried out at the time of adjusting the stereoscopic effect in the third embodiment. FIG. 14 is a diagram for explaining a process carried out at the time of adjusting the stereoscopic effect in the third embodiment.

The polynocular camera according to the third embodiment is mainly characterized in that only the subjects, which are within a predetermined range of the centers of images, are specified as subjects targeted for display position adjustment, among the subjects which are located forward away from the provisional cross point position and the cross point position is gradually adjusted from the provisional cross point to the cross point position after adjustment such that the subjects targeted for display position adjustment do not move forward away from the cross point position after adjustment.

The polynocular camera according to the third embodiment differs from the polynocular camera according to the first embodiment only in the configuration of the three-dimensional processing unit.

As shown in FIG. 12, the three-dimensional processing unit 30b of the present embodiment includes a blur circuit 41, a feature point detection circuit 42, a vector detection circuit 43, a projecting region calculation circuit 44, a display image cut-out position calculation circuit 45, and a projecting region position determination circuit 46. The blur circuit 41 administers a blur process to the subjects to be blurred within the images GR, GL. The feature point detection circuit 42 detects a feature point from either one of the images GR, GL and detects a corresponding point from the other image, which corresponds to the feature point in the one image. Further, the blur circuit 41 and the feature point detection circuit 42 obtain face detection coordinate information within the images GR, GL from face detection (not shown) and carry out necessary processes to be described below. The vector detection circuit 43 calculates a vector between each feature point and a corresponding point corresponding thereto. The projecting region calculation circuit 44 identifies subjects to be projected forward from the cross point within images being processed as subjects to be blurred. The projecting region position determination circuit 46 sets only the subjects that fall within the predetermined range of the centers of images to be candidates for subjects targeted for display position adjustment, among the subjects which are located forward away from the provisional cross point position, as shown in FIG. 14. The display image cut-out position calculation circuit 45 identifies subjects to be projected forward from the cross point within images being processed as subjects targeted for display position adjustment, among the candidates for the subjects targeted for display position adjustment, which has been set by the projecting region position determination circuit 46, and adjusts a position at which the display range is gradually cut out from the images GR, GL such that a subject targeted for display position adjustment is caused to be the cross point position.

Next, a process carried out in the third embodiment will be described.

For example, when displaying stereoscopic images such as live view images, still images and through-the-lens images on the monitor 20, two images GR, GL for generating stereoscopic images are obtained at first (step S201) It should be noted that the images GR, GL are attached with cut-out position shift flag information that is set OFF in an initial state. Further, a cut-out position of a display area of each of the images GR, GL is determined based on the state in which the center of each of the images GR, GL is set as a cross point position which is a provisional position (the initial state).

Next, either one of the images is used as a reference to detect feature points f from the reference image (step S202). In the present embodiment, the left image GL is assumed to be a reference image. Then, corresponding points m corresponding to the feature points f within the reference image are detected from the other image (the right image GR in the present embodiment) (step S203). Then, vector values between each feature point f and a corresponding point m corresponding thereto is calculated (step S204), and a feature point having the greatest vector value is extracted from thereamong (step S205).

Next, a determination is made as to whether each cut-out position shift flag of the images GR, GL is ON (step S206). If the result of the determination is negative, a determination is made as to whether the greatest vector value which has been detected in step S205 exceeds a predetermined value (V_limit) (step S207). In the present embodiment, V_limit is assumed to be 0. Thus, it is assumed here that subjects which are located even slightly forward from the cross point are those which are projected excessively forward.

The result of the initial determination in step S206 is always negative because the initial state of the cut-out position shift flag is OFF, and thereby the process moves to step S207. If the result of the determination in step S207 is negative, the process is terminated.

In the case that the result of the determination in step S207 is affirmative, the feature points f and corresponding points m of the subjects are detected from the images GR, GL, and then only the feature points f and corresponding points m having a vector value which exceeds a predetermined value are extracted to extract objects o (subjects to be blurred) including the extracted feature points f/corresponding points m (step S208). The predetermined value may be the same as or different from that of step S207. However, it is assumed here that the predetermined valued is the same value (V_limit) in the present embodiment. Further, regarding a method for extracting objects, various existing methods may be employed.

Next, the extracted object o is subjected to the blur process (step S209). Here, the blur process may employ filters such as a Gaussian filter, or may use a simple averaging process. The details of the blur process are the same as those of the first embodiment described above.

Next, a determination is made as to whether the subjects to be blurred, which have been extracted in step S208 fall within the predetermined range of the center of the display areas of the images GR, GL. In the case that the result of the determination is negative, the process is terminated. In the case that the result of the determination is affirmative in step S208, a determination is made as to whether each cut-out position shift flag of the images GR, GL is ON (step S211). In the case that the result of the determination is negative, the shift amount of the cut-out position from a current cut-out position (the provisional position in the first process cycle) to a cut-out position after adjustment is calculated (step S215). The result of the initial determination in step S211 is always negative because the initial state of the cut-out position shift flag is OFF, and the process inevitably moves to step S215. In this case, the cut-out position after adjustment may be set to any position, at which the amount the subjects that falls within the predetermined range of the center of the display areas of the images GR, GL are projected forward from the cross point, becomes small. However, it is preferable for the cut-out position after adjustment to be a position, at which the feature point of the object that falls within the predetermined range of the center of the display areas of the images GR, GL is set as the cross point position, i.e., a position at which no subject is ultimately displayed forward of the cross point position. The details of the cut-out position after adjustment other than the above are the same as those of the first embodiment described above.

Next, the shift amount of the cut-out position which has been calculated in step S215 is divided into a plurality numbers of portions, and the cut-out position is shifted by one step for each process. In addition, if each cut-out position shift flag of the images GR, GL is OFF, these flags are changed to ON (step S216). In this case, the division number and the division of the shift amount of cut-out position are the same as those of the first embodiment described above.

When step S216 is completed, the step returns to step S201 again. Hereafter, the same processes as those in the first cycle will be carried out. However, since the cut-out position shift flag is ON in the second and subsequent cycles, the result of the determination in step S206 will be different from that in the first cycle, thereby directly moving to step S208. Moreover, the result of the determination in step S211 will also be different from that in the first cycle, and thereby the process moves to step S212.

In step S212, a determination is made as to whether the shift of cut-out position for display is completed. If the result of the determination is negative, the process moves to step S216 to shift the cut-out position by one step and then returns to step S201 again.

In the case that the result of the determination in step S212 is affirmative, i.e., the feature point having the greatest vector value among the feature points of the objects that fall within the predetermined range of the center of the display areas of the images GR, GL is set as the cross point position, each cut-out position shift flag of the images GR, GL will be changed to OFF (step S213). Then, if the blur process is completed, the blur process will be suspended (step S214), thereby terminating the process.

The timing of the above processes is the same as that in the first embodiment described above.

Even when the above configuration is adopted, the same advantageous effects as those obtained by the first embodiment described above can be obtained. Basically, it is often the case that the main subject is in the vicinity of the center of images, and it is considered that the user is unlikely to pay attention to subjects at the periphery of the images. Thus, in the present embodiment, in the case that the subjects at the periphery of the images are projected forward, only the blur process is carried out thereon. This can reduce the burden on user's eyes, and prevent the stereoscopic effect of the stereoscopic images from being excessively deteriorated.

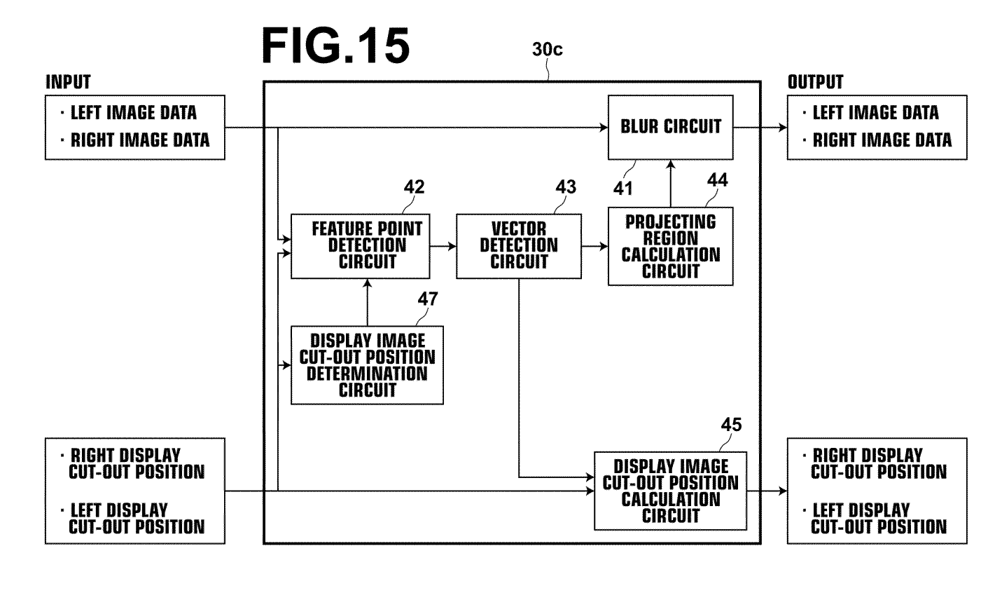

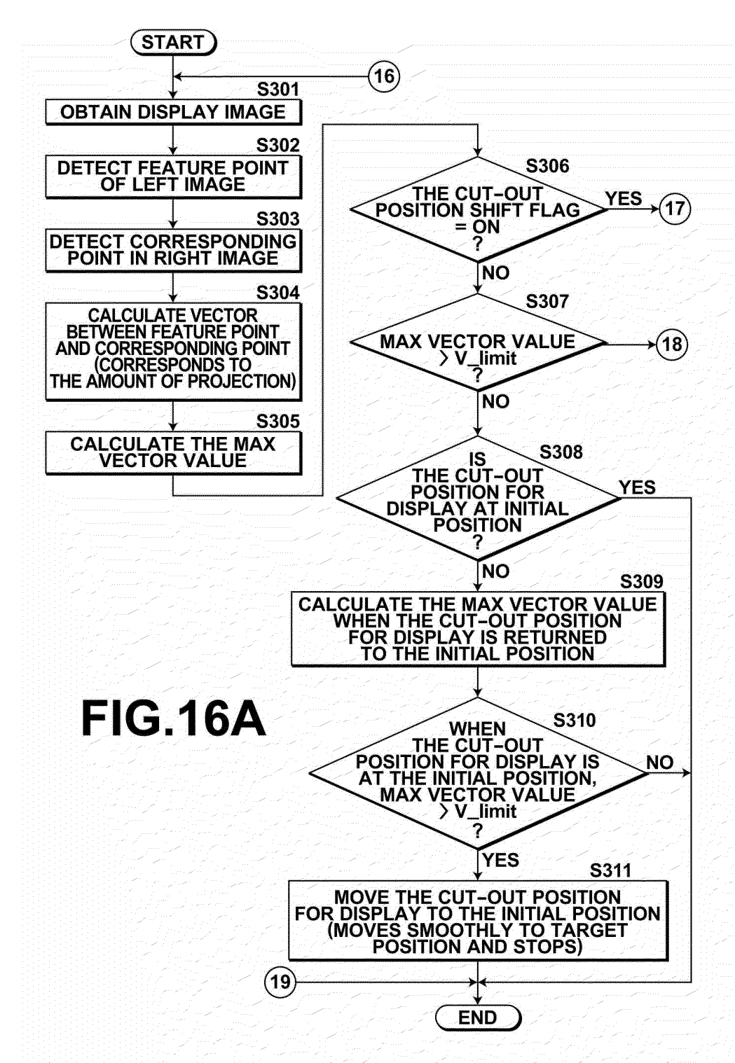

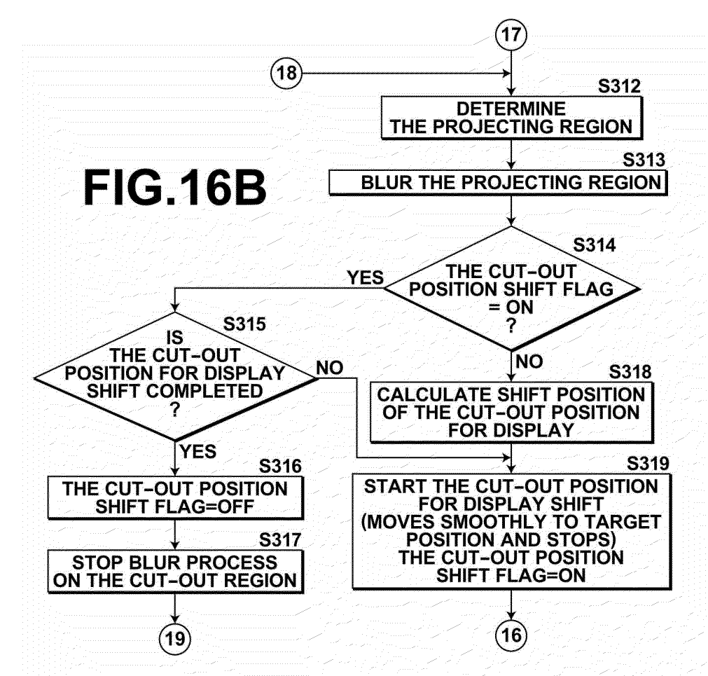

Next, a fourth embodiment of the present invention will be described. It should be noted that a polynocular camera, to which an image processing apparatus according to the fourth embodiment of the invention is applied, has substantially the same configuration as that of a polynocular camera 1 according to the first embodiment, and therefore detailed descriptions of the same constituent elements will be omitted here. FIG. 15 is a schematic block diagram that illustrates a three dimensional processing unit of a polynocular camera, to which an image processing apparatus according to a fourth embodiment of the present invention is applied. FIG. 16 is a flow chart that illustrates a process carried out at the time of adjusting the stereoscopic effect in the fourth embodiment.

The polynocular camera according to the fourth embodiment is mainly characterized in that a position of the cross point is returned from the cross point position after adjustment to the provisional position, in the case that subjects targeted for display position adjustment is shifted out of the image.

The polynocular camera according to the fourth embodiment differs from the polynocular camera according to the first embodiment only in the configuration of the three-dimensional processing unit.

As shown in FIG. 15, the three-dimensional processing unit 30c of the present embodiment includes a blur circuit 41, a feature point detection circuit 42, a vector detection circuit 43, a projecting region calculation circuit 44, a display image cut-out position calculation circuit 45 and a display image cut-out position determination circuit 47. The blur circuit 41 administers a blur process to the subjects to be blurred within the images GR, GL. The feature point detection circuit 42 detects a feature point from either one of the images GR, GL and detects a corresponding point from the other image, which corresponds to the feature point in the one image. Further, the blur circuit 41 and the feature point detection circuit 42 obtain face detection coordinate information within the images GR, GL from face detection (not shown) and carry out necessary processes to be described below. The vector detection circuit 43 calculates a vector between each feature point and a corresponding point corresponding thereto. The projecting region calculation circuit 44 identifies subjects to be projected forward from the cross point within images being processed as subjects to be blurred. The display image cut-out position calculation circuit 45 identifies subjects to be projected forward from the cross point within images being processed as subjects targeted for display position adjustment and adjusts a position at which the display range is gradually cut out from the images GR, GL such that a subject targeted for display position adjustment is caused to be the cross point position. The display image cut-out position determination circuit 47 determines whether the current cut-out position is in the initial position, and in the case that the result of the determination is negative, the difference between the current cut-out position and the initial position is calculated.

Next, a process carried out in the fourth embodiment will be described. When compared to the processes carried out in the first embodiment, the present embodiment includes additional steps S308 through S311. Therefore, only these steps will be mainly described, and the details of the other steps will be omitted here.

After carrying out the same processes as those in the first embodiment, and thereby moving to step S306, a determination is made as to whether the greatest vector value which has been detected in step S305 exceeds a predetermined value (V_limit) (step S307). In the present embodiment, V_limit is assumed to be 0. Thus, it is assumed here that subjects which are located even slightly forward from the cross point are those which are projected excessively forward.

In the case that the result of the determination in step S307 is affirmative, the same processes as those in the first embodiment will be carried out thereafter.

In the case that the result of the determination in step S307 is negative, a determination is made as to whether the cut-out position of each display area in the images GR, GL is the initial position (step S308). In the case that the result of the determination is affirmative, the process is terminated.

In the case that the result of the determination in step S308 is negative, the greatest vector value between a feature point and a corresponding point corresponding thereto within images GR, GL is calculated (step S309) after the cut-out positions of the display areas of the images GR, GL are returned to the initial positions, respectively. Then, a determination is made as to whether this vector value exceeds the predetermined value (V_limit) (step S310).

In the case that the result of the determination in step S310 is negative, the process is terminated. In the case that the result of the determination in step S310 is affirmative, the cut-out positions of the display areas of the images GR, GL are moved to the initial position, respectively (step S311), and thereby the process is terminated. In this case, it is preferable for the cut out positions to be gradually shifted.

Even when the above-configuration is adopted, the same advantageous effects as those obtained by the first embodiment described above can be obtained. Further, there is no need to suppress the stereoscopic effect of images for which it is not necessary to suppress the stereoscopic effect. Therefore, this can prevent the stereoscopic effect of stereoscopic images from being excessively deteriorated.

Apparatuses related to the embodiments of the invention have been described. In addition, the invention may be implemented as a program for causing a computer to function as means corresponding to the three-dimensional processing unit 30 described above to carry out the process of each embodiment. The invention may also be implemented as a computer-readable recording medium containing such a program.

Further, the image processing apparatus according to the invention is not limited to application to polynocular cameras, but may be applied to any other apparatus such as an image display device.

What is claimed is:

1. An image processing apparatus that sets a predetermined point which corresponds to each other within a plurality of images with different viewpoints as a cross point and generates a stereoscopic image which is stereoscopically displayed on a display means for stereoscopic display by performing a parallax adjustment on the plurality of images such that parallax becomes 0 at the position of the cross point, comprising:
parallax amount calculation means for calculating a parallax amount among the plurality of images for each subject within the images;
subject targeted for display position adjustment identification means for identifying a subject having an absolute parallax value which exceeds a first predetermined amount as a subject targeted for display position adjustment, using a cross point provisionally set for the plurality of images as a reference;
parallax adjustment means for gradually adjusting parallax such that the absolute parallax value of the subject targeted for display position adjustment does not exceed a second predetermined amount after adjustment;
subject to be blurred identification means for identifying a subject having an absolute parallax value which exceeds a third predetermined amount as a subject to be blurred, in each of an image having the provisional cross-point position, an image undergoing parallax adjustment, and an image after the parallax adjustment; and
image processing means for performing a blur process on the subject to be blurred within the images.

2. The image processing apparatus as claimed in claim 1, wherein the image processing means performs the blur process on the subjects to be blurred at higher degrees as the absolute parallax value of the subject to be blurred is increased.

3. The image processing apparatus as claimed in claim 1, wherein the parallax adjustment means adjusts parallax in not less than three stages.

4. The image processing apparatus as claimed in claim 2, wherein the parallax adjustment means adjusts parallax in not less than three stages.

5. The image processing apparatus as claimed in claim 1, further comprising:
face detection means for detecting a face within images; and wherein the parallax adjustment means specifies only the face as the subject targeted for the parallax adjustment.

6. The image processing apparatus as claimed in claim 2, further comprising:
face detection means for detecting a face within images; and wherein the parallax adjustment means specifies only the face as the subject targeted for the parallax adjustment.

7. The image processing apparatus as claimed in claim 3, further comprising:
face detection means for detecting a face within images; and wherein the parallax adjustment means specifies only the face as the subject targeted for the parallax adjustment.

8. The image processing apparatus as claimed in claim 4, further comprising:
face detection means for detecting a face within images; and wherein the parallax adjustment means specifies only the face as the subject targeted for the parallax adjustment.

9. The image processing apparatus as claimed in claim 1, wherein the parallax adjustment means specifies only the subject that is within a predetermined range of the center of the image as the subject targeted for display position adjustment.

10. The image processing apparatus as claimed in claim 2, wherein the parallax adjustment means specifies only the subject that is within a predetermined range of the center of the image as the subject targeted for display position adjustment.

11. The image processing apparatus as claimed in claim 3, wherein the parallax adjustment means specifies only the subject that is within a predetermined range of the center of the image as the subject targeted for display position adjustment.

12. The image processing apparatus as claimed in claim 4, wherein the parallax adjustment means specifies only the subject that is within a predetermined range of the center of the image as the subject targeted for display position adjustment.

13. The image processing apparatus as claimed in claim 1, wherein the parallax adjustment means adjusts parallax such that a position of the cross point is returned to an initial position, in the case that the subject targeted for display position adjustment is moved out of the images.

14. An image processing method for setting a predetermined point which corresponds to each other within a plurality of images with different viewpoints as a cross point and generating a stereoscopic image which is stereoscopically displayed on display means for stereoscopic display by performing parallax adjustment on the plurality of images such that parallax becomes 0 at the position of the cross point, characterized by comprising:
calculating a parallax amount among the plurality of images for each subject within the images;
identifying a subject having an absolute parallax value which exceeds a first predetermined amount as a subject targeted for display position adjustment, using a cross point provisionally set for the plurality of images as a reference;
gradually adjusting parallax such that the absolute parallax value of the subject targeted for display position adjustment does not exceed a second predetermined amount after adjustment;
identifying a subject having an absolute parallax value which exceeds a third predetermined amount as a subject to be blurred, in each of an image having the provisional cross point position, an image undergoing parallax adjustment, and an image after parallax adjustment; and
blurring the subject to be blurred within images.

15. The image processing method as claimed in claim 14, wherein the blur process is performed on the subject to be blurred at higher degrees as the absolute parallax value of the subject to be blurred is increased.

16. The image processing method as claimed in claim 14, further comprising:
detecting a face within the images
specifying only the face as the subject targeted for display position adjustment.

17. The image processing method as claimed in claim 15, further comprising:
detecting a face within the images; and
specifying only the face as the subject targeted for display position adjustment.

18. The image processing method as claimed in claim 14, wherein only the subject, which is within the predetermined range of the center of the images, is specified as the subject targeted for display position adjustment.

19. The image processing method as claimed in claim 15, wherein only the subject, which is within the predetermined range of the center of the images, is specified as the subject targeted for display position adjustment.

20. The image processing method as claimed in claim 14, wherein in the case that the subject targeted for display position adjustment is moved out of the image, parallax is adjusted such that a cross point position is returned to an initial position.
